(19) United States
(12) Patent Application Publication
(10) Pub. No.: US 2018/0033006 A1
(43) Pub. Date: Feb. 1, 2018

(54) METHOD AND SYSTEM FOR IDENTIFYING AND ADDRESSING POTENTIAL FICTITIOUS BUSINESS ENTITY-BASED FRAUD

(71) Applicant: Intuit Inc., Mountain View, CA (US)

(72) Inventors: Jonathan R. Goldman, Mountain View, CA (US); Monica Tremont Hsu, Burlingame, CA (US); Efraim Feinstein, Palo Alto, CA (US)

(73) Assignee: Intuit Inc., Mountain View, CA (US)

(21) Appl. No.: 15/220,854

(22) Filed: Jul. 27, 2016

(51) Int. Cl. G06Q 20/40; G06F 21/62; H04L 29/06; G06Q 40/00

(52) U.S. Cl. CPC G06Q 20/405; G06Q 40/10; G06F 21/6218; H04L 63/102

(57) ABSTRACT

Methods and systems of the present disclosure include identifying and addressing potential fictitious business entity-based fraud, according to one embodiment. The methods and systems identify fictitious business entities associated with fraudulent tax return filings, in one embodiment. According to one embodiment, the methods and systems acquire data associated with an employer identification number (EIN), apply the data to one or more predictive models to generate one or more risk scores to identify potentially suspicious EIN data, and perform one or more risk reduction actions based on the one or more risk scores, according to one embodiment.

### BACKGROUND

Financial services are diverse and valuable tools, offering resources that were either never before available, or were previously available only through interaction with a human professional. For example, a financial service may provide tax preparation or financial management services. Prior to the advent of financial services, a user would be required to consult with a tax preparation or financial management professional for services and the user would be limited, and potentially inconvenienced, by the hours during which the professional was available for consultation. Furthermore, the user might be required to travel to the professional's physical location. Beyond the inconveniences of scheduling and travel, the user would also be at the mercy of the professional's education, skill, personality, and varying moods. All of these factors resulted in a user who was vulnerable to human error, variations in human ability, and variations in human temperament.

Some financial systems provide services that human professionals are not capable of providing, and even those financial systems that provide services that are similar to services that have historically been provided by human professionals offer many benefits, such as: not having limited working hours, not being geographically limited, and not being subject to human error or variations in human ability or temperament. Because financial systems represent a potentially flexible, highly accessible, and affordable source of services, they have the potential of attracting both positive and negative attention.

Fraudsters (cybercriminals) target financial systems to obtain money or financial credit using a variety of unethical techniques. For example, fraudsters can target tax return preparation systems to obtain tax refunds and/or tax credits based on legitimate and/or illegitimate information for legitimate or fictional business entities.

As an example of fraudulent activity against a tax return preparation system, a gang of fraudsters could potentially pool electronic and knowledge resources to steal millions of dollars in tax refunds during a single tax season. Such an experience can be traumatic for current tax return preparation system users and can have a chilling effect on potential future users of the tax return preparation system. Such security risks are bad for tax filers and can damage relations between tax filers and tax preparation service providers.

Fraudsters can create fictitious business entities as one technique for committing fraud on the Internal Revenue Service (“IRS”). In using a fictitious business entity, a fraudster might form a small business, put one or more people (e.g., stolen identities) on the payroll, and actually file forms with the state and/or federal government. Thus, the fraudster has actually/legally created an entity, but the entity is fictitious, the payroll exists as a smokescreen, and the forms are filed to give the veneer of legitimacy.

Once the fraudster has created a fictitious business entity, the fraudster files tax returns for one or more employees, though the fictitious business entity likely will not actually have paid money to any of the employees of record. Then, the fraudster can receive tax refunds associated with the fictitious employees of the fictitious business entity.

Fictitious business entity-based fraud hurts taxpayers by stealing resources that would otherwise benefit state and federal governments and individuals. What is needed is a method and system for identifying and addressing potential fictitious business entity-based fraud, according to one embodiment.

### SUMMARY

Fictitious business entity-based fraud is an example of cybercrime that includes creating a business entity for the purpose of filing tax returns for fraudulent tax returns on behalf of fictitious employees of the fictitious business. Although the business may be an entity registered with the government and assigned an Employer Identification Number (“EIN”), the business entity itself may be fictitious, e.g., existing only for the purpose of filing fraudulent tax returns. For example, a fraudster may form a fictitious business entity, get an EIN (as is required by the federal government of most businesses) and file one or more tax returns as an employee of the fictitious business entity, using the EIN on the tax returns.

Although service providers of financial systems are not contributing to the fictitious business entity-based fraud, potential fictitious business entity-based fraud is a major concern to the service providers of the financial systems as they work to minimize fraudulent activity and to protect their customers' financial interests.

The present disclosure includes methods and systems for identifying and addressing potential fictitious business entity-based fraud in a financial system, according to one embodiment. To identify and address the potential fictitious business entity-based fraud, a security system monitors financial data to identify potentially suspicious EIN data.

In one embodiment, the security system receives financial data including EIN data, generates one or more risk scores based on the EIN data, and performs one or more risk reduction actions based on the likelihood of potential fictitious business entity-based fraud that is represented by the one or more risk scores, according to one embodiment.

The one or more risk scores individually and/or cumulatively represent a likelihood of potential fictitious business entity-based fraud, according to one embodiment. In one embodiment, the EIN data associated with one or more risk scores that individually and/or cumulatively represent a likelihood of potential fictitious business entity-based fraud is defined as potentially suspicious EIN data.

Each potentially suspicious EIN is associated with a subset of financial data stored and/or maintained by the financial systems and/or the security system, according to one embodiment. The security system processes the financial data to determine various types of risk scores, according to one embodiment. The one or more risk scores include risk scores for risk categories such as characteristics of an IP address of a user computing system used to access the financial system, user system characteristics of a user computing system used to access the financial system, system access characteristics, an account of a user for the financial system, user characteristics of a user of the financial system, entity characteristics of an entity associated with the EIN, tax preparer characteristics, and tax return characteristics, according to one embodiment.

In one embodiment, the characteristics of the IP address of the user computing system used to access the financial system include geographic location of the IP address, whether the IP address is static or dynamic, and/or whether the IP address is residential, corporate, or another type of IP address.

In one embodiment, the entity characteristics of the entity associated with the EIN include the age of the entity associated with the EIN, time elapsed since the EIN was issued, a change in number of employees associated with the EIN, number of refunds associated with the EIN, a change in number of refunds associated with the EIN, amount of refunds associated with an EIN, a change in amount of refunds associated with an EIN, change in entity income, change in entity employee income, number of employees, change in number of employees

In one embodiment, the tax preparer characteristics include age of the tax preparer, identity characteristics, a number of filings associated with a particular copy of tax return software,

In one embodiment, the tax return characteristics include a bank account provided for returns, date of filings, closeness of filings in time, time of day of filings, and percentage of individuals associated with the EIN receiving a return.

The security system generates the one or more risk scores using one or more predictive models that are trained to identify potential fictitious business entity-based fraud, according to one embodiment. The one or more predictive models are trained using EIN data that has been associated with fictitious business entity-based fraud, which enables the one or more predictive models to generate scores that represent the likelihood of fictitious business entity-based fraud based on analysis of prior cases, according to one embodiment.

The risk reduction actions include one or more techniques to address potential fictitious business entity-based fraud, according to one embodiment. The risk reduction actions include, but are not limited to, preventing a user from taking action within the financial system, including preventing a user from making a filing within the financial system; preventing a filing associated with the potentially suspicious EIN; reporting the user to the IRS; reporting the user's actions to the IRS; reporting the potentially suspicious EIN to the IRS; alerting an individual potentially as to potentially suspicious EIN associated with a filing that they may be associated with the filing. Additional embodiments of risk reduction actions are disclosed in more detail below.

The security system generates the one or more risk scores and performs the one or more risk reduction actions based on information in addition to the financial data, according to one embodiment. In one embodiment, the security system uses one or more of filing characteristics data; user characteristics data; system access data; and/or user system data, according to one embodiment.

In one embodiment, the security system receives system access data for a user account. The system access data includes information associated with a user interacting with the financial system, according to one embodiment. The system access data represents system access activities of one or more users with the financial system, according to one embodiment. The system access data includes, but is not limited to, duration of access to the financial system, number of user experience pages visited in the financial system, time of access, identification of the computing system used to access the financial system, an Internet browser and/or an operating system of the computing system used to access the financial system, clickstream data generated while accessing the financial system, Internet Protocol (“IP”) address characteristics of the computing system used to access the financial system, and the like. Additional examples of system access data and/or system access activities are provided below.

The security system works with the financial system to identify and address the potentially fraudulent activity, according to one embodiment. In one embodiment, the functionality/features of the security system are integrated into the financial system. In one embodiment, the security system shares one or more resources with the financial system in a service provider computing environment. In one embodiment, the security system requests the information that is used for identification of potentially fraudulent activity from the financial system. In one embodiment, the financial system is one of the following: a tax return preparation system, a personal financial management system, and a business financial management system.

These and other embodiments of the financial system and the security system are discussed in further detail below.

By identifying and addressing potential fictitious business entity-based fraud, implementation of embodiments of the present disclosure allows for significant improvement to the fields of data security, financial systems security, electronic tax return preparation, data collection, and data processing, according to one embodiment.

As illustrative examples, by identifying and addressing potential fictitious business entity-based fraud, fraudsters can be deterred from criminal activity, financial system providers may retain/build trusting relationships with customers, governments may be spared financial losses, criminally funded activities may be decreased due to less or lack of funding, and tax refunds may be delivered to authorized recipients faster (due to less likelihood of unauthorized recipients).

As another example, by identifying and implementing risk reducing actions, tax filer complaints to the Internal Revenue Service (“IRS”) and to financial system service providers may be reduced. As a result, embodiments of the present disclosure allow for reduced communication channel bandwidth utilization and faster communications connections. Consequently, computing and communication systems implementing and/or providing the embodiments of the present disclosure are transformed into faster and more operationally efficient devices and systems.

### BRIEF DESCRIPTION OF THE DRAWINGS

FIG. 1 is a block diagram of software architecture for identifying and addressing potential fictitious business entity-based fraud in a financial system, in accordance with one embodiment.

FIG. 2 is a flow diagram of a process for identifying and addressing potential fictitious business entity-based fraud, according to one embodiment.

FIG. 3 is a flow diagram of a process for identifying and addressing potential fictitious business entity-based fraud, according to one embodiment.

FIG. 4 is a flow diagram of a process for identifying and addressing potential fictitious business entity-based fraud, according to one embodiment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for identifying and addressing potential fictitious business entity-based fraud activity in a financial system, according to various embodiments.

### Introductory System

Herein, a system (e.g., a software system) can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data, in one embodiment.

As used herein, the term system includes, but is not limited to the following: computing system implemented, and/or online, and/or web-based, personal and/or business tax preparation systems; computing system implemented, and/or online, and/or web-based, personal and/or business financial management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of systems include, but are not limited to the following: TurboTax™ available from Intuit, Inc. of Mountain View, Calif.; TurboTax Online™ available from Intuit, Inc. of Mountain View, Calif.; QuickBooks™, available from Intuit, Inc. of Mountain View, Calif.; QuickBooks Online™, available from Intuit, Inc. of Mountain View, Calif.; Mint™, available from Intuit, Inc. of Mountain View, Calif.; Mint Online™, available from Intuit, Inc. of Mountain View, Calif.; and/or various other systems discussed herein, and/or known to those of skill in the art at the time of filing, and/or as developed after the time of filing. In one embodiment, data obtained from use of TurboTax and/or TurboTax Online is not used in any other the other systems that are available from Intuit, Inc. of Mountain View, Calif.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given system as that system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the system in the production environment such as a data center, a cloud computing environment, a dedicated hosting environment, and/or one or more other computing environments in which one or more assets used by the application in the production environment are implemented; one or more computing systems or computing entities used to implement at least part of the system in the production environment; one or more virtual assets used to implement at least part of the system in the production environment; one or more supervisory or control systems, such as hypervisors, or other monitoring and management systems used to monitor and control assets and/or components of the production environment; one or more communications channels for sending and receiving data used to implement at least part of the system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the system in the production environment; one or more databases used to store data in the production environment; one or more internal or external services used to implement at least part of the system in the production environment; one or more backend systems, such as backend servers or other hardware used to process data and implement at least part of the system in the production environment; one or more modules/functions used to implement at least part of the system in the production environment; and/or any other assets/components making up an actual production environment in which at least part of the system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the system.

In various embodiments, one or more cloud computing environments are used to create, and/or deploy, and/or operate at least part of the system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience display” includes not only data entry and question submission user interfaces, but also other user experience features and elements provided or displayed to the user such as, but not limited to the following: data entry fields, question quality indicators, images, backgrounds, avatars, highlighting mechanisms, icons, buttons, controls, menus and any other features that individually, or in combination, create a user experience, as discussed herein, and/or as known in the art at the time of filing, and/or as developed after the time of filing.

As used herein, the term “user experience” includes not only the user session, interview process, interview process questioning, and/or interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

Herein, the term “entity,” “party,” “user,” “user consumer,” and “customer” are used interchangeably to denote any party and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “predictive model” is used interchangeably with “analytics model” and denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the term “Employer Identification Number,” or “EIN,” also known as a Federal Tax Identification Number, is assigned by a state or federal government and is used to identify a business entity, according to one embodiment.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein the term “system access data” denotes data that represents the activities of a user during the user's interactions with a financial system, and represents system access activities and the features and/or characteristics of those activities, according to various embodiments.

As used herein, the term “risk categories” denotes characteristics, features, and/or attributes of users or client systems, and represents subcategories of risk that may be used to quantify potentially fraudulent activity, according to various embodiments.

### Hardware Architecture

The present disclosure includes methods and systems for identifying and addressing potential fictitious business entity-based fraud in a financial system, according to one embodiment. In one embodiment, a security system identifies and addresses potential fictitious business entity-based fraud in a tax return preparation system. To identify and address the potential fictitious business entity-based fraud, the security system receives financial data including EIN data from a client system, generates one or more risk scores based on the EIN data, and performs one or more risk reduction actions based on the likelihood of potential fictitious business entity-based fraud that is represented by the one or more risk scores, according to one embodiment.

In other words, in one embodiment, when a user prepares or provides a tax filing that includes EIN data within a tax return preparation system, the tax return preparation system monitors the EIN data to identify tax filings associated with one EIN. That is, in one embodiment, the tax return preparation system identifies tax filings that share a common EIN.

In one embodiment, the financial system creates and stores filing data that represents the tax filings. In one embodiment, the financial system creates and stores EIN data that represents the EIN. In one embodiment, the financial system creates and stores tax return preparation data representing tax return preparation information from one or more users of a financial system. As disclosed below, the security system uses the filing data, the EIN data, and/or the tax return preparation data, as well as other input data, to generate risk scores and to perform risk reduction actions, according to various embodiments.

To identify potential fictitious business entity-based fraud, the security system analyzes data associated with the EIN to identify patterns indicative of fraudulent activity. For example, a single tax preparation professional filing multiple tax returns for multiple employees who are all employed by a single business entity, and are therefore all associated with a single EIN, may indicate potential fictitious business entity-based fraud. Another indication of potential fictitious business entity-based fraud is if one tax preparation professional only files tax returns for employees of one company. In these scenarios, it is possible that the presumed tax preparation professional may actually be a fraudster who has created a fictitious company for the purpose of filing fraudulent tax returns on behalf of fictitious employees.

As discussed herein, embodiments of the present disclosure identify and address potential fictitious business entity-based fraud by analyzing patterns and/or factors indicative of fraudulent activity. In one embodiment, the software system analyzes several factors concurrently, with predictive models, to determine the likelihood of potential fictitious business entity-based fraud.

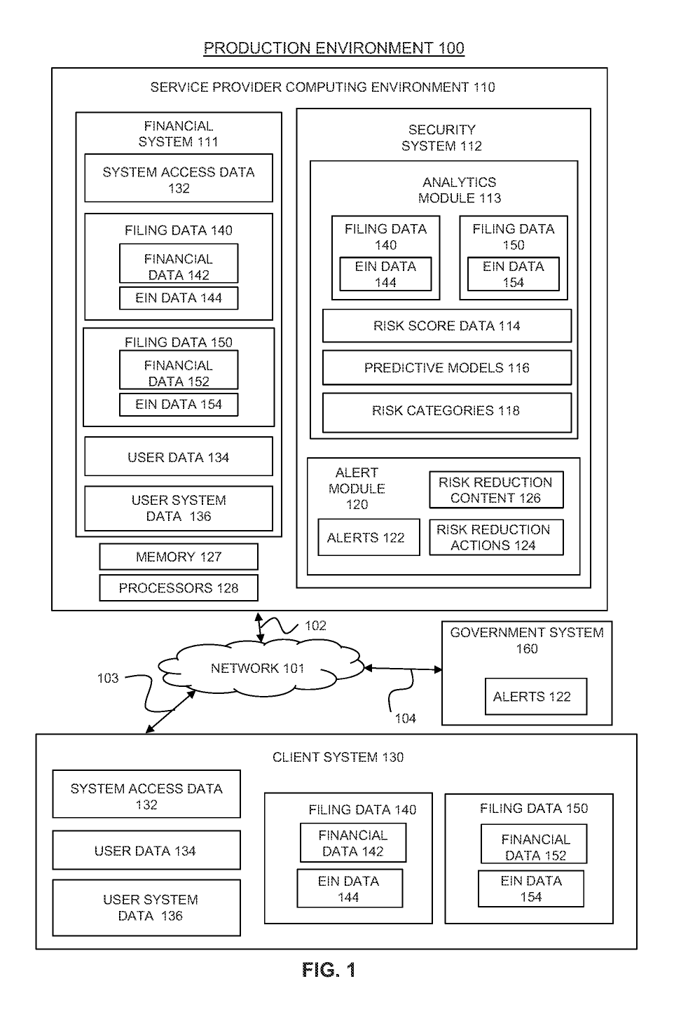

FIG. 1 is an example block diagram of a production environment 100 for identifying and addressing potential fictitious business entity-based fraud in a financial system, in accordance with one embodiment. The production environment 100 illustrates example communications between a service provider computing environment 110, a client system 130, and a government system 160, to describe embodiments of how a security system may identify and address potential fictitious business entity-based fraud in a financial system 111, in one embodiment.

The service provider computing environment 110 is communicatively coupled to the client system 130 and the government system 160 through a network 101 and through communications channels 102, 103, and 104, according to one embodiment.

In one embodiment, the client system 130 is used to communicate with and/or interact with the financial system 111, according to one embodiment. The client system 130 is representative of one of hundreds, thousands, or millions of user systems used by users to access the financial system 111, according to one embodiment. In one embodiment, only one authorized user uses the client system 130 to access the financial system. In one embodiment, the client system 130 is a family computer or a public computer that is used by multiple authorized users to access the financial system 111.

In one embodiment, the client system 130 includes system access data 132; user data 134; user system data 136; filing data 140, including financial data 142 and EIN data 144; and filing data 150, including financial data 152 and EIN data 154.

The system access data 132 is data that represents system access activities and the features and/or characteristics of those activities, according to one embodiment. The system access activities may occur before, during, and/or after the client system 130 establishes a communications channel/connection with the financial system 111, according to one embodiment. The system access data 132 includes, but is not limited to, data representing the following: user entered data, event level data, interaction behavior, the web browser of a user's computing system, the operating system of a user's computing system, the media access control (“MAC”) address of the user's computing system, hardware identifiers of the user's computing system, user credentials used for logging in, a user account identifier, the IP address of the user's computing system, a session identifier, interaction behavior during prior sessions, interaction behavior using different computing systems to access the financial system 111, interaction behavior from IP addresses other than a current IP address, IP address characteristics, whether changes are made to user characteristics data, and any other feature/characteristic of system access activity that is currently known at the time of filing or that may be known at a later time for interacting with a financial system, according to one embodiment. In one embodiment, event level data includes data that represents events such as filing a tax return, logging into a user account, entering information into the user account, navigating from one user experience page to another, and the like.

In one embodiment, the user data 134 includes user characteristics data. The user data 134 includes personally identifiable information (“PII”), according to one embodiment. Personally identifiable information includes, but is not limited to, a Social Security number, employer identification number, driver's license number, home address, combinations of other user data 134, or any other information that can be used to distinguish one user and/or individual (e.g., person or organization) from another, according to one embodiment.

In addition to personally identifiable information, the user data 134 includes, but is not limited to, data representing the following: browsing/navigation behavior within the financial system 111, type of web browser, type of operating system, manufacturer of computing system, whether the user's computing system is a mobile device or not, a user's name, a Social Security number, government identification, a driver's license number, a date of birth, an address, a zip code, a home ownership status, a marital status, an annual income, a job title, an employer's address, spousal information, children's information, asset information, medical history, occupation, information regarding dependents, salary and wages, interest income, dividend income, business income, farm income, capital gain income, pension income, individual retirement account (“IRA”) distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial system or in providing one or more financial services, according to various embodiments.

The user system data 136 include one or more of an operating system, a hardware configuration, a web browser, information stored in one or more cookies, the geographical history of use of the client system 130, an IP address associated with the client system 130, and other forensically determined characteristics/attributes of the client system 130, according to one embodiment. The user system data 136 are represented by a user system characteristics identifier that corresponds with a particular set of user system characteristics during one or more user sessions with the financial system 111, according to one embodiment. Because the client system 130 may use different browsers or different operating systems at different times to access the financial system 111, the user system data 136 for the client system 130 may be assigned several user system characteristics identifiers, according to one embodiment. The user system characteristics identifiers are called the visitor identifiers (“VIDs”), according to one embodiment.

The IP address associated with the client system 130 is part of the user system data 136 and can be static, can be dynamic, and/or can change based on the location (e.g., a coffee shop) for which the client system 130 accesses the financial system 111, according to one embodiment. The financial system 111 and/or the security system 112 may use an IP address identifier to represent the IP address and/or additional characteristics of the IP address associated with the client system 130, according to one embodiment.

The user clickstream data associated with client system 130 is part of the user system data 136 and represents the browsing/navigation behavior of one or more of users of the client system 130 while interacting with the financial system 111, according to one embodiment. The clickstream data associated with client system 130 is captured and/or stored in the system access data 132 and/or the user data 134, according to one embodiment.

The user system characteristics are part of the user system data 136 and are associated with a user system characteristics identifier, which can be generated based on a combination of the hardware and software used by the client system 130 to access the financial system 111 during one or more sessions, according to one embodiment. The user system characteristics are associated with a user system characteristics identifier, which can be generated based on a combination of the hardware and software used by the client system 130 to access the financial system 111, according to one embodiment. As discussed above, the system access data 132 and/or the user data 134 include the user system characteristics, the IP address associated with the client system 130, and the clickstream data associated with the client system 130, according to one embodiment.

In one embodiment, the filing data 140 includes, but is not limited to, any filing related to the financial data 142, such as a tax return. The financial data 142 includes, but is not limited to, first financial data representing financial data for a first individual including the following: one or more previous years' tax returns, an incomplete tax return, salary information, tax deduction information, tax liability history, personal budget information, partial or whole bank account information, personal expenditures, accounts receivable, accounts payable, annual profits for business, financial institution money transfer history, checking accounts, savings accounts, lines of credit, and the like, according to one embodiment.

In one embodiment, the EIN data 144 includes an “Employer Identification Number” also known as a Federal Tax Identification Number, associated with the filing data 140. In one embodiment, the EIN data 144 is identical to the EIN data 154. In one embodiment, the term “Employer Identification Number” or “EIN” represents any employer or business entity identifier that is used or generated by the financial system 111 and/or a state or federal government entity to identify the employer or business entity.

In one embodiment, the filing data 150 includes, but is not limited to, any filing related to the financial data 152, such as a tax return. The financial data 152 includes, but is not limited to, second financial data representing financial data for a second individual including the following: one or more previous years' tax returns, and incomplete tax return, salary information, tax deduction information, tax liability history, personal budget information, partial or whole bank account information, personal expenditures, accounts receivable, accounts payable, annual profits for business, financial institution money transfer history, checking accounts, savings accounts, lines of credit, and the like, according to one embodiment.

In one embodiment, the EIN data 154 includes an “Employer Identification Number” also known as a Federal Tax Identification Number, associated with the filing data 150. In one embodiment, the EIN data 154 is identical to the EIN data 144.

In one embodiment, the client system 130 is the source of the filing data 140 and the filing data 150 because the client system 130 is used to file tax returns for a first person/employee (e.g., with filing data 140) and for a second person/employee (e.g., with filing data 150). Accordingly, the client system 130 represents a single client system used by a fraudster to file multiple potentially fraudulent tax returns, according to one embodiment.

In one embodiment, the client system 130 is the source of the filing data 140 and the filing data 150 because the client system 130 is used to execute a professional version of a tax return preparation system to fraudulently file tax returns for a first person/employee (e.g., with filing data 140) and for a second person/employee (e.g., with filing data 150). Accordingly, the client system 130 represents a single client system and/or a single copy of a professional version of a tax return preparation system that is used by a fraudster to file multiple potentially fraudulent tax returns, according to one embodiment.

The service provider computing environment 110 includes the financial system 111 and the security system 112 that is used to identify and address potential fictitious business entity-based fraud in the financial system 111, according to one embodiment. The service provider computing environment 110 includes one or more centralized, distributed, and/or cloud-based computing systems that are configured to host the financial system 111 and the security system 112 for a service provider (e.g., Intuit®), according to one embodiment. The financial system 111 establishes one or more user accounts with one or more users of the client system 130 by communicating with the client system 130 through the network 101, according to one embodiment.

The security system 112 uses information from the financial system 111 to identify the activities of the client system 130 as potentially fraudulent, to determine the likelihood of potentially fictitious business entity-based fraudulent activity from the client system 130, and to take one or more risk reduction actions to prevent fraudulent activity in the financial system 111, according to one embodiment.

The financial system 111 provides one or more financial services to users of the financial system 111, according to one embodiment. Examples of financial services include, but are not limited to, tax return preparation services, personal financial management services, business financial management services, and the like. The financial system 111 enables users, such as the users of the client system 130, to interact with the financial system 111 based on one or more user accounts that are associated with the users of the client system 130, according to one embodiment.

The financial system 111 acquires, receives, maintains and/or stores the system access data 132; the filing data 140, including the financial data 142 and the EIN data 144; the filing data 150, including the financial data 152 and the EIN data 154; the user data 134; and the user system data 136, according to one embodiment.

The financial system 111 creates, stores, and manages the system access data 132, at least partially based on interactions of client systems, including client system 130, with the financial system 111, according to one embodiment. The system access data 132 is stored as a table, a database, or some other data structure, according to one embodiment. The system access data 132 can include tens, hundreds, or thousands of features or characteristics associated with an interaction between a client system and the financial system 111, according to one embodiment.

In one embodiment, the security system 112 uses the system access data 132 that is based on one or more sessions between the financial system 111 and the client system 130 to identify and address potentially fraudulent activities, according to one embodiment. For example, the security system 112 analyzes the system access data 132 at least partially based on the number and characteristics of sessions entered into by a particular client system, according to one embodiment. A session-by-session analysis of system access data 132 can be used to show which client systems are accessing multiple user accounts, in addition to the nature/behavior of the accesses, according to one embodiment.

The financial system 111 creates, stores, and/or manages the filing data 140, in one embodiment. In one embodiment, the filing data 140 includes financial data 142. The financial data 142 is stored in a table, database, or other data structure, according to one embodiment. The financial system 111 receives and/or obtains the financial data 142 directly from the client system 130, according to one embodiment. The financial system 111 receives and/or obtains the financial data 142 from one or more third party systems, such as payroll management systems, public records, government agencies, etc., according to one embodiment.

The financial system 111 creates, stores, and/or manages the user data 134 that is associated with users of the financial system 111, according to one embodiment. In one embodiment, the user data 134 is stored in a table, database, or some other data structure, according to one embodiment.

To determine the likelihood that an EIN associated with the client system 130 (or any other client system) is associated with potentially fictitious business entity-based fraud activities, the security system 112 uses an analytics module 113 and an alert module 120, according to one embodiment. Although embodiments of the functionality of security system 112 will be described in terms of the analytics module 113 and the alert module 120, the security system 112, the financial system 111, and/or service provider computing environment 110 may use one or more alternative terms and/or techniques for organizing the operations, features, and/or functionality of the security system 112 that is described herein. In one embodiment, the security system 112 (or the functionality of the security system 112) is partially or wholly integrated/incorporated into the financial system 111.

The security system 112 generates risk score data 114 for EIN data 144 and EIN data 154, to determine a likelihood of potential fictitious business entity-based fraud in the financial system 111, according to one embodiment. In one embodiment, the EIN data 144 and EIN data 154 represent the same EIN.

The analytics module 113 and/or the security system 112 acquire filing data 140, including EIN data 144, and filing data 150, including EIN data 154 from the financial system 111 and/or from a centralized location where the filing data 140 and filing data 150 are stored for use by the financial system 111, according to one embodiment.

The analytics module 113 and/or the security system 112 applies the filing data 140 and filing data 150 to one or more predictive models 116, to generate the risk score data 114 that represents one or more risk scores, according to one embodiment. In one embodiment, the analytics module 113 and/or the security system 112 applies the filing data 140 to one or more predictive models 116, to generate the risk score data 114 that represents one or more risk scores. In one embodiment, the analytics module 113 and/or the security system 112 applies the filing data 150 to one or more predictive models 116, to generate the risk score data 114 that represents one or more risk scores.

In one embodiment, the analytics module 113 and/or the security system 112 applies various input data to one or more predictive models 116, to generate the risk score data 114 that represents one or more risk scores.

The analytics module 113 and/or the security system 112 defines the likelihood of potential fictitious business entity-based fraud at least partially based on the risk scores (represented by the risk score data 114) that are output from the one or more predictive models 116, according to one embodiment.

The analytics module 113 and/or the security system 112 uses one or more of the predictive models 116 to generate risk score data 114 for one or more risk categories 118, according to one embodiment.

In one embodiment, the risk categories 118 represent characteristics, features, and/or attributes of one or more of the EIN, financial system product (e.g., Lacerte®, proconnect™, etc.), financial system identifier, system access, tax preparer, business entity, tax preparation, tax filing, user system, user system identifier, IP address, IP address identifier, user account, and user account identifier.

In one embodiment, the risk categories are defined as one or more of the following: Employer Identification Number risk category; Employer Identification Number characteristics risk category; financial system product identifier risk category; financial system product characteristics risk category; system access characteristics risk category; tax preparer characteristics risk category; business entity characteristics risk category; tax preparation characteristics risk category; tax filing characteristics risk category; user system characteristics risk category; user system characteristics identifier risk category; IP address risk category; IP address identifier risk category; user account risk category; and user account identifier risk category.

In one embodiment, input data for the risk categories 118 include EIN data, financial system product data, financial system identifier data, system access data, tax preparer data, business entity data, tax preparation data, tax filing data, user system data, user system identifier data, IP address data, IP address identifier data, user account data, and user account identifier data.

In one embodiment, each of the predictive models 116 receives the input data and generates a risk score (represented by the risk score data 114) for each of the risk categories 118.

To illustrate with an example, in one embodiment, the analytics module 113 receives filing data 140. In one embodiment, the analytics module 113 applies the filing data 140 to one of the predictive models 116. In one embodiment, the predictive model generates a risk score of 0.72 (represented by the risk score data 114) for the filing data 140 of the client system 130.

In one embodiment, the analytics module 113 and/or the security system 112 determines whether a risk score of 0.72 is a strong enough indication of a security threat to warrant performing one or more risk reduction actions.

As described, in one embodiment, the security system 112 uses one or more of the filing data 140, the financial data 142, the EIN data 144, the filing data 150, the financial data 152, the EIN data 154, the system access data 132, the user data 134, and the user system data 136 to determine the likelihood that the client system 130 is participating in potential fictitious business entity-based fraud during use of the financial system 111, according to one embodiment.

Each of the predictive models 116 can be trained to generate the risk score data 114 based on multiple risk categories 118, according to one embodiment. Each of the one or more predictive models 116 can be trained to generate a risk score or risk score data 114 for one particular risk category (e.g., Employer Identification Number risk category, financial system product identifier risk category, tax preparer characteristics risk category, business entity characteristics risk category, etc.), according to one embodiment.

The risk score data 114 represents a risk score that is a number (e.g., a floating-point number) ranging from 0-1 (or some other range of numbers), according to one embodiment. In one embodiment, the closer the risk score is to 0, the lower the likelihood is that potential fictitious business entity-based fraud has occurred and/or is occurring for a particular risk category. In one embodiment, the closer the risk score is to 1, the higher the likelihood is that potential fictitious business entity-based fraud has occurred and/or is occurring for a particular risk category.

For example, if the analytics module returns a risk score of 0.82 for the financial system product identifier risk category, it would be more likely than not that the financial system product (e.g., a professional version of a tax return preparation system that is installed on a particular client) has been used to perform actions that one or more of the predictive models 116 has been trained to identify as potential fictitious business entity-based fraud, according to one embodiment.

One or more of the predictive models 116 is trained using information from the financial system 111 that has been identified or reported as being linked to some type of fraudulent activity, according to one embodiment. For example, in one embodiment, personnel associated with the financial system 111 learn that a financial system product used to file tax returns was purchased with a stolen credit card. When the personnel investigate the filings prepared using the financial system product, they may determine that the financial system product was associated with potential fictitious business entity-based fraud, in one embodiment. The personnel then provide, to the security system, the information that is associated with the financial system product that was purchased with the stolen credit card. By providing the information to the security system 112, the security system 112 is able to use the information to train one or more of the predictive models 116 to detect similar occurrences of fraudulent activity, according to one embodiment.

One or more predictive model building techniques is applied to the system access data 132, user data 134, user system data 136, filing data 140 and 150, financial data 142 and 152, and/or EIN data 144 and 154 to generate one or more of the predictive models 116 for one or more of the risk categories 118, according to one embodiment. One or more predictive model building techniques is applied to fraud data that is reported to the security system 112 by customer support personnel or by fraud investigation teams, to generate one or more of the predictive models 116, according to one embodiment.

The one or more predictive models 116 are trained using one or more of a variety of machine learning techniques including, but not limited to, regression, logistic regression, decision trees, artificial neural networks, support vector machines, linear regression, nearest neighbor methods, distance based methods, naive Bayes, linear discriminant analysis, k-nearest neighbor algorithm, or another mathematical, statistical, logical, or relational algorithm to determine correlations or other relationships between the likelihood of potential fictitious business entity-based fraud activity and the fraud data that is reported to the security system 112 by customer support personnel or by fraud investigation teams, according to one embodiment.

The analytics module 113 and/or the security system 112 can use the risk scores represented by the risk score data 114 in a variety of ways, according to one embodiment. In one embodiment, a determination to take corrective action or to take risk reduction actions is based on a risk score for one of the risk categories 118. In one embodiment, a determination to take corrective action or to take risk reduction action is based on a combination of risk scores for two or more of the risk categories 118.

In one embodiment, the predictive models 116 are applied to EIN data that represents a low likelihood for potential fictitious business entity-based fraud as well as to EIN data that represents a high likelihood for potential fictitious business entity-based fraud, to define risk score thresholds to apply to the risk score data 114, according to one embodiment. In one embodiment, the risk score data 114 is compared to one or more predefined risk score thresholds to determine if one or more of the risk categories 118 has a high enough likelihood of potential fictitious business entity-based fraud characteristics to warrant performing risk reduction actions. Examples of risk score thresholds include 0.8 for EIN, 0.95 for tax preparer, and 0.65 for tax filing, according to one example of an embodiment. These values are merely illustrative and are determined based on applying the predictive models 116 to existing input data, according to one embodiment.

By defining and applying risk score thresholds to the risk score data 114, the security system 112 can control the number of false-positive and false-negative determinations of potentially fraudulent activity between client systems and/or business entities associated with client systems and the financial system 111, according to one embodiment. When a business entity is identified as having a high likelihood of association with potential fictitious business entity-based fraud, the security system 112 executes one or more risk reduction actions 124, according to one embodiment.

However, if the security system 112 flags a business entity as having a high likelihood of association with potential fictitious business entity-based fraud when the business entity is not associated with potential fictitious business entity-based fraud, then the flagged activity is a false-positive and the user associated with the business entity is inconvenienced with proving he or she is not associated with potential fictitious business entity-based fraud and/or with being blocked from accessing the financial system 111, according to one embodiment. Thus, tuning the financial system 111 and/or the risk score thresholds to control the number of false-positive determinations will improve users' experience with the financial system 111, according to one embodiment.

A less-desirable scenario than flagging a business entity as false-positive might be flagging a business entity as false-negative for potential fictitious business entity-based fraud in the financial system 111, according to one embodiment. If the security system 112 flags the business entity as not being potentially fraudulent when in fact the business entity has a high likelihood of being a potentially fictitious business entity, then the non-flagged business entity is a false-negative, and the potentially fictitious business entity has a continued opportunity to commit fraud, according to one embodiment. Thus, tuning the financial system and/or the risk score thresholds to control the number of false-negative determinations will improve the ability of the financial system 111 to identify and address potential fictitious business entity-based fraud, according to one embodiment.

The security system 112 uses the alert module 120 to execute one or more risk reduction actions 124, upon determining that all or part of the risk score data 114 indicates a likelihood of potential fictitious business entity-based fraud, according to one embodiment. The alert module 120 is configured to coordinate, initiate, or perform one or more risk reduction actions 124 in response to detecting and/or generating one or more alerts 122, according to one embodiment. The alert module 120 and/or the security system 112 is configured to compare the risk score data 114 to one or more risk score thresholds to quantify the level of risk associated with one or more system access activities and/or associated with one or more client systems, according to one embodiment. The alerts 122 include one or more flags or other indicators that are triggered, in response to at least part of the risk score data 114 exceeding one or more risk score thresholds, according to one embodiment. The alerts 122 include an alert for each one of the risk categories 118 that exceeds a predetermined and/or dynamic risk score threshold, according to one embodiment. The alerts 122 include a single alert that is based on a sum, an average, or some other holistic consideration of the risk scores associated with the risk categories 118, according to one embodiment.

If at least part of the risk score data 114 indicates that potential fictitious business entity-based fraud is occurring or has occurred, the alert module uses risk reduction content 126 and performs one or more risk reduction actions 124 to attempt to address the potential fictitious business entity-based fraud, according to one embodiment.

The risk reduction content 126 includes, but is not limited to, banners, messages, audio clips, video clips, avatars, other types of multimedia, and/or other types of information that can be used to notify a system administrator, customer support, a user associated with an account that is under inspection, a government entity, and/or a state or federal revenue service, according to one embodiment.

In one embodiment, the risk reduction actions 124 include, but are not limited to, one or more of alerting the financial system of the likelihood of potential fictitious business entity-based fraud, to enable the financial system to adjust (e.g., increase) scrutiny of activity associated with the potentially suspicious EIN and/or notify appropriate authorities.

In one embodiment, the risk reduction actions 124 include, but are not limited to, one or more of: notifying a state, local, or federal revenue service of potentially fraudulent activity associated with a potentially suspicious EIN; requesting information from a point of contact for the potentially suspicious EIN; obtaining point of contact information for the potentially suspicious EIN from a secretary of state office to determine a financial history of a point of contact associated with the point of contact information; suspending tax return filings associated with the potentially suspicious EIN; suspending access to the financial system for user accounts associated with the potentially suspicious EIN; notifying a potentially fraudulent user that the user's activities have been flagged as potentially fraudulent; and assigning customer support representatives for the financial system to contact people who were employed by the business entity associated with the potentially suspicious EIN.

In one embodiment, risk reduction actions 124 include notifying a state, local, or federal government of potential fictitious business entity based fraud. In one embodiment, the state, local, or federal government is notified of potential fictitious business entity based fraud via a government system 160. In one embodiment, the government system 160 is provided the alerts 122 (e.g., from the financial system 111 and/or from the security system 112).

In one embodiment, the security system 112 analyzes input data in a batch mode. For example, the security system 112 periodically (e.g., at the end of each day, week, and/or month) fetches or receives fraudulent data and/or other input data to perform analysis and/or model training to detect potential fictitious business entity-based fraud associated with the financial system 111, according to one embodiment.

In one embodiment, the security system 112 provides real-time potential fictitious business entity-based fraud identification and remediation services. Each time filing data is received, the financial system 111 executes and/or calls the services of the security system 112 to generate risk score data 114 for the filing data, financial data, and/or EIN data for each session or request for access to the filing system 111, according to one embodiment. In one embodiment, the security system 112 continuously or periodically (e.g., every 1, 5, 10, 15 minutes, etc.) applies input to the one or more predictive models 116 to generate risk score data 114.

The service provider computing environment 110 and/or the financial system 111 and/or the security system 112 includes memory 127 and processors 128 to support operations of the financial system 111 and/or of the security system 112 in identifying and addressing potential fictitious business entity-based fraud in the financial system 111, according to one embodiment. In one embodiment, the security system 112 includes instructions that are represented as data that are stored in the memory 127 and that are executed by one or more of the processors 128 to perform a method of identifying and addressing potential fictitious business entity-based fraud in the financial system 111.

By receiving various information from the financial system 111, analyzing the received information, quantifying a likelihood of risk based on the information, and performing one or more risk reduction actions 124, the security system 112 works with the financial system 111 to improve the security of the financial system 111, according to one embodiment. In addition to improving the security of the financial system 111, the security system 112 protects financial interests of the government and of customers of the service provider, to maintain and/or improve the security and functionality of the financial system 111, according to one embodiment. Furthermore, the security system 112 addresses the Internet-centric problem of cyber criminals using fictitious business entities to file fraudulent tax returns on behalf of fictitious employees, according to one embodiment.

### Process

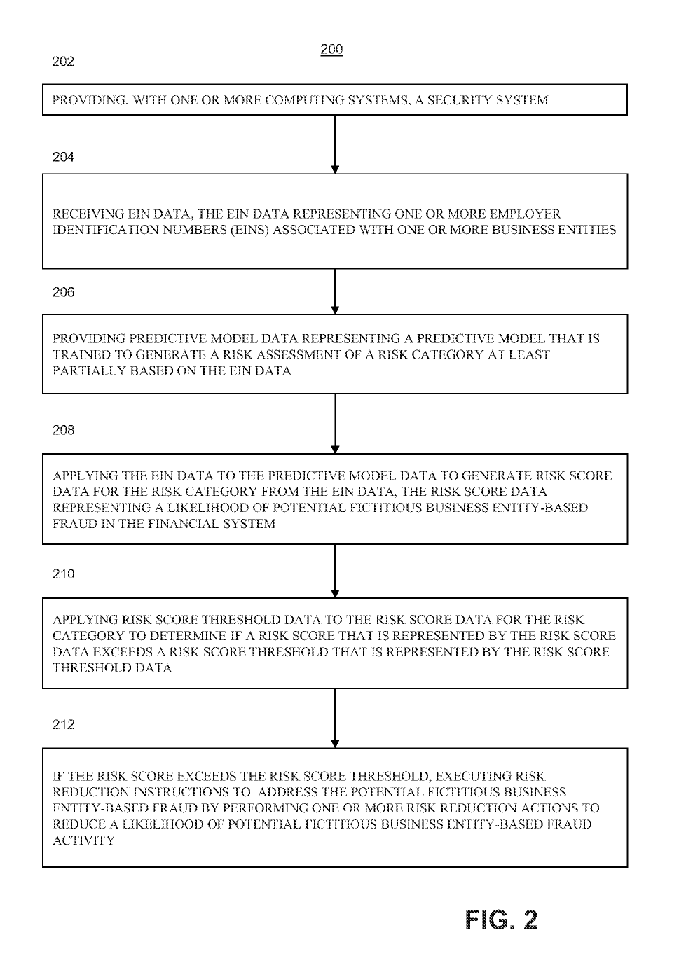

FIG. 2 illustrates an example flow diagram of a process 200 for identifying and addressing potential fictitious business entity-based fraud.

At operation 202, the process 200 includes providing, with one or more computing systems, a security system, according to one embodiment. Operation 202 proceeds to operation 204, according to one embodiment.

In one embodiment, at operation 204, the process 200 includes receiving EIN data, the EIN data representing one or more Employer Identification Numbers (“EINs”) associated with one or more business entities. According to one embodiment, operation 204 proceeds to operation 206.

At operation 206, the process 200 includes providing predictive model data representing a predictive model that is trained to generate a risk assessment of a risk category at least partially based on the EIN data, in one embodiment. In one embodiment, operation 206 proceeds to operation 208.

At operation 208, the process 200 includes applying the EIN data to the predictive model data to generate risk score data for the risk category from the EIN data, the risk score data representing a likelihood of potential fictitious business entity-based fraud in the financial system, according to one embodiment. Operation 208 proceeds to operation 210, in one embodiment.

According to one embodiment, at operation 210, the process 200 includes applying risk score threshold data to the risk score data for the risk category to determine if a risk score that is represented by the risk score data exceeds a risk score threshold that is represented by the risk score threshold data. In one embodiment, operation 210 proceeds to operation 212.

At operation 212, if the risk score exceeds the risk score threshold, the process 200 includes executing risk reduction instructions to address the potential fictitious business entity-based fraud by performing one or more risk reduction actions to reduce a likelihood of potential fictitious business entity-based fraud activity, according to one embodiment.

In one embodiment, the process 200 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential fictitious business entity-based fraud.

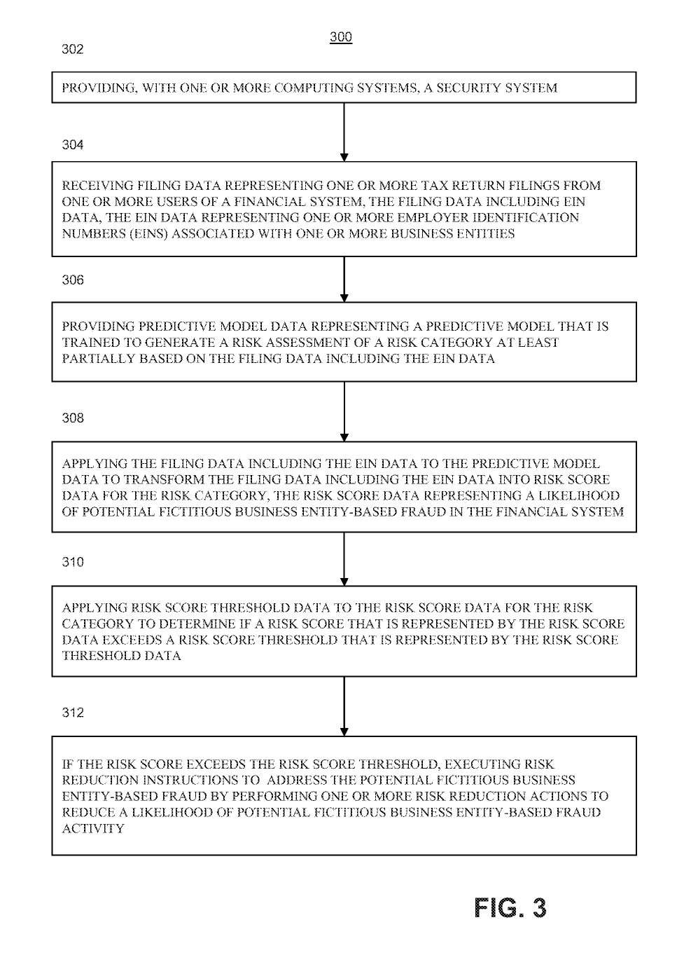

FIG. 3 illustrates an example flow diagram of a process 300 for identifying and addressing potential fictitious business entity-based fraud, according to one embodiment.

At operation 302, the process 300 includes providing, with one or more computing systems, a security system, according to one embodiment. Operation 302 proceeds to operation 304, according to one embodiment.

At operation 304, the process 300 includes receiving filing data representing one or more tax return filings from one or more users of a financial system, the filing data including EIN data, the EIN data representing one or more Employer Identification Numbers (EINs) associated with one or more business entities, in one embodiment. In one embodiment, operation 304 proceeds to operation 306.

At operation 306, the process 300 includes providing predictive model data representing a predictive model that is trained to generate a risk assessment of a risk category at least partially based on the filing data including the EIN data, in one embodiment.

In one embodiment, the risk category includes an Employer Identification Number risk category; an Employer Identification Number characteristics risk category; a financial system product identifier risk category; a financial system product characteristics risk category; a risk category system access characteristics; a tax preparer characteristics risk category; a business entity characteristics risk category; tax preparation characteristics risk category; a tax filing characteristics risk category; a user system characteristics risk category; a user system characteristics identifier risk category; an IP address risk category; an IP address identifier risk category; a user account risk category; and a user account identifier risk category.

In one embodiment, the business entity characteristics risk category includes one or more of the following characteristics: age of the business entity; change in number of employees of the business entity; change in income of employee and/or employees of the business entity; and change in income of the business entity.

In one embodiment, the Employer Identification Number characteristics risk category includes EIN characteristics, wherein at least one characteristic of the EIN characteristics includes one or more of the following characteristics of the EIN: date of EIN creation; and duration of EIN use by a business entity associated with the EIN.

In one embodiment, the tax preparer characteristics risk category includes tax preparer characteristics such as a Preparer Tax Identification Number (“PTIN”) associated with a tax return preparer. In one embodiment, the tax preparer characteristics risk category includes tax preparer characteristics such as whether multiple tax filings associated with the EIN are prepared by one tax preparer; a number of tax filings in the financial system that have been submitted by a tax preparer on behalf of other people; and how long a tax preparer has used the financial system to prepare tax returns on behalf of other people.

For example, in one embodiment, if more than one tax return associated with the EIN is filed by one tax preparer, the risk of the EIN as being potentially suspicious is higher than if each tax return associated with the EIN is filed by a different tax preparer.

In one embodiment, the tax filing characteristics risk category includes tax filing characteristics such as the percentage of individuals associated with the EIN receiving a refund. In one embodiment, the higher the percentage of individuals associated with the EIN receiving a refund, the more likely the business entity associated with the EIN is associated with potential fictitious business entity-based fraud.

In one embodiment, the process 300 includes training one or more predictive models. In one embodiment, the process 300 includes training and re-training one or more predictive models. In one embodiment, the process 300 includes training and re-training one or more predictive models, on a periodic basis (e.g., at the end of each business day). In one embodiment, the process 300 includes training predictive models and/or re-training existing predictive models based on additional data samples (e.g., fraud data samples) acquired from the financial system and/or security system, according to one embodiment. For example, process 300 includes training new predictive models and/or retraining existing predictive models after 10, 50, 100, etc. additional fraudulent activities are identified, to assist new predictive models in more accurately identifying subsequent cases of potential fictitious business entity-based fraud, according to one embodiment.

In one embodiment, process 300 includes requesting one or more of system access data, the filing data, financial data, user data, and user system data associated with the potentially suspicious EIN data and applying a predictive model training operation to one or more of the system access data, the filing data, the financial data, the user data, and the user system data associated with the potentially suspicious EIN data, to generate the predictive model data and to train the predictive model.

In one embodiment, the system access data includes one or more of data representing features or characteristics associated with an interaction between a client system and the financial system; data representing a web browser of a client system; data representing an operating system of a client system; data representing a media access control address of the client system; data representing user credentials used to access the user account; data representing a user account; data representing a user account identifier; data representing interaction behavior between a client system and the financial system; data representing characteristics of an access session for the user account; data representing an IP address of a client system; and data representing characteristics of an IP address of the client system.

In one embodiment, the predictive model training operation includes one or more of regression; logistic regression; decision tree; artificial neural network; support vector machine; linear regression; nearest neighbor analysis; distance based analysis; naive Bayes; linear discriminant analysis; and k-nearest neighbor analysis.

In one embodiment, operation 306 proceeds to operation 308.

At operation 308, the process 300 includes applying the filing data including the EIN data to the predictive model data to transform the filing data including the EIN data into risk score data for the risk category, the risk score data representing a likelihood of potential fictitious business entity-based fraud in the financial system, in one embodiment.

In one embodiment, all EIN data received by the financial system is applied to the predictive model data.

In one embodiment, all EIN data associated with entities created after a predetermined date are applied to the predictive model data. For example, in one embodiment, all EIN data associated with entities created less than one year prior to a present date are applied to the predictive model data. In one embodiment, all EIN data associated with entities created less than two years prior to a present date are applied to the predictive model data. In one embodiment, all EIN data associated with entities created less than three years prior to a present date are applied to the predictive model data. In one embodiment, operation 308 proceeds to operation 310.

According to one embodiment, operation 310 includes applying risk score threshold data to the risk score data for the risk category to determine if a risk score that is represented by the risk score data exceeds a risk score threshold that is represented by the risk score threshold data.

In one embodiment, multiple predictive models are provided. In one embodiment, each risk category corresponds with an individual predictive model. The risk scores of the multiple predictive models are individually compared to their own risk score thresholds, to determine if any of the risk categories exceed a corresponding risk score threshold, according to one embodiment. In one embodiment, operation 310 proceeds to operation 312.

At operation 312, according to one embodiment, if the risk score exceeds the risk score threshold, the process 300 includes executing risk reduction instructions to address the potential fictitious business entity-based fraud by performing one or more risk reduction actions to reduce a likelihood of potential fictitious business entity-based fraud activity.

In one embodiment, if the risk scores are less than the risk score thresholds, the process 300 does not execute risk reduction instructions. In one embodiment, if the risk scores are equal to or less than the risk score thresholds, the process 300 does not execute risk reduction instructions.

In one embodiment, if the risk score exceeds the risk score threshold, the process 300 classifies the EIN data of the filing data that was transformed into the risk score data as potentially suspicious EIN data.

In one embodiment, risk reduction actions include one or more of alerting the financial system of the likelihood of potential fictitious business entity-based fraud, to enable the financial system to increase scrutiny of activity associated with the potentially suspicious EIN and/or notify appropriate authorities.

In one embodiment, risk reduction actions include one or more of notifying a state or federal revenue service of potentially fraudulent activity associated with the potentially suspicious EIN; requesting information from a point of contact for the potentially suspicious EIN; obtaining point of contact information for the potentially suspicious EIN from a secretary of state office to determine a financial history of a point of contact associated with the point of contact information; suspending tax return filings associated with the potentially suspicious EIN; suspending access to the financial system for user accounts associated with the potentially suspicious EIN; notifying a potentially fraudulent user that the user's activities have been flagged as potentially fraudulent; and assigning customer support representatives for the financial system to contact people who were employed by the business entity associated with the potentially suspicious EIN.

By suspending access to the financial system for user accounts associated with the potentially suspicious EIN, the process 300 prevents potentially fraudulent activity from occurring or further occurring within the financial system, in one embodiment.

In one embodiment, the process 300 notifies a potentially fraudulent user that the user's activities have been flagged as potentially fraudulent by displaying a message within a user interface that the current session may be or is being terminated, according to one embodiment. In one embodiment, the financial system is configured to display an on-screen message that notifies the potentially fraudulent user that a message will be provided to the intended recipient of the filing data through one or more of an email, a text message, or a telephone call, according to one embodiment.

In one embodiment, the process 300 emails, text messages, or calls the indented recipient of the filing data to notify the intended recipient of the filing data of potential fictitious business entity-based fraud, according to one embodiment.

In one embodiment, the process 300 includes executing risk reduction instructions if any of the risk scores exceed their corresponding risk score thresholds, according to one embodiment.

In one embodiment, the process 300 includes executing risk reduction instructions if the average, sum, or other normalized result of the risk scores exceeds a general risk score threshold, according to one embodiment.

In one embodiment, the process 300 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential fictitious business entity-based fraud.

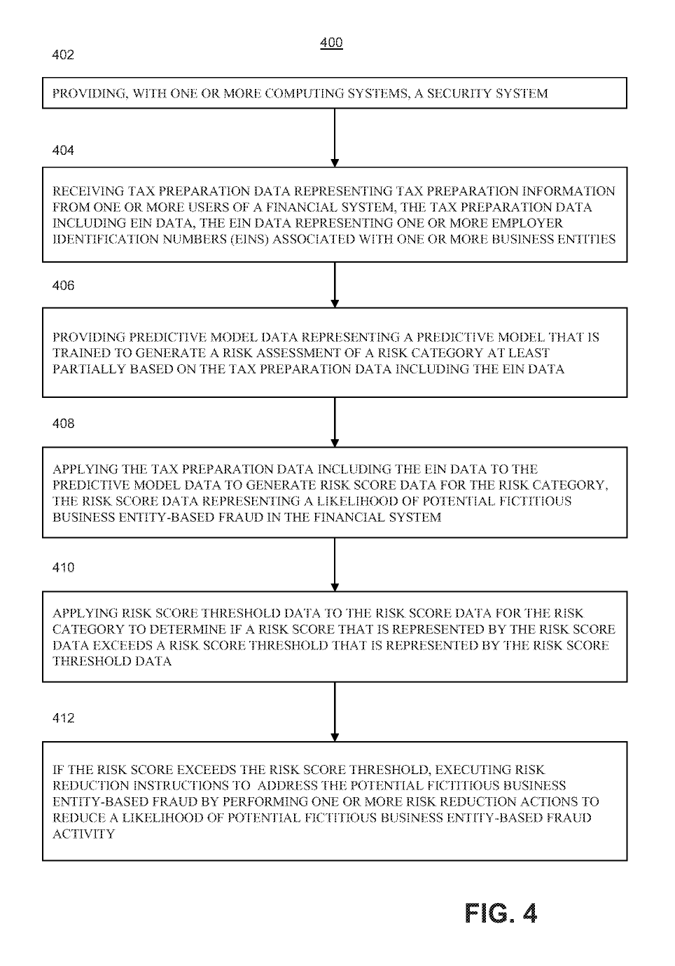

FIG. 4 illustrates an example flow diagram of a process 400 for identifying and addressing potential fictitious business entity-based fraud.

At operation 402, the process 400 includes providing, with one or more computing systems, a security system, according to one embodiment. Operation 402 proceeds to operation 404, according to one embodiment.

At operation 404, the process 400 includes receiving tax preparation data representing tax preparation information from one or more users of a financial system, the tax preparation data including EIN data, the EIN data representing one or more Employer Identification Numbers (EINs) associated with one or more business entities, according to one embodiment. Operation 404 proceeds to operation 406, according to one embodiment.

At operation 406, the process 400 includes providing predictive model data representing a predictive model that is trained to generate a risk assessment of a risk category at least partially based on the tax preparation data including the EIN data, according to one embodiment. Operation 406 proceeds to operation 408, in one embodiment.

At operation 408, the process 400 includes applying the tax preparation data including the EIN data to the predictive model data to generate risk score data for the risk category, the risk score data representing a likelihood of potential fictitious business entity-based fraud in the financial system, in one embodiment. Operation 408 proceeds to operation 410, in one embodiment.

At operation 410, the process 400 includes applying risk score threshold data to the risk score data for the risk category to determine if a risk score that is represented by the risk score data exceeds a risk score threshold that is represented by the risk score threshold data, according to one embodiment. In one embodiment, operation 410 proceeds to operation 412.

At operation 412, if the risk score exceeds the risk score threshold, the process 400 includes executing risk reduction instructions to address the potential fictitious business entity-based fraud by performing one or more risk reduction actions to reduce a likelihood of potential fictitious business entity-based fraud activity.

In one embodiment, the process 400 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential fictitious business entity-based fraud.

As noted above, the specific illustrative examples discussed above are but illustrative examples of implementations of embodiments of the method or process for identifying and addressing potential fictitious business entity-based fraud. Those of skill in the art will readily recognize that other implementations and embodiments are possible. Therefore the discussion above should not be construed as a limitation on the claims provided below.

By identifying and addressing potential fraudulent activity (e.g., potential business entity-based fraud) in a financial system, implementation of embodiments of the present disclosure allows for significant improvement to the fields of data security, financial systems security, electronic tax return preparation, data collection, and data processing, according to one embodiment. As illustrative examples, by identifying and addressing potentially fraudulent activity, fraudsters can be deterred from criminal activity, the government and taxpayers may be spared financial losses, criminally funded activities may be decreased due to less or lack of funding, tax refunds may be delivered to authorized recipients faster (due to less likelihood of unauthorized recipients). As a result, embodiments of the present disclosure allow for reduced communication channel bandwidth utilization, and faster communications connections. Consequently, computing and communication systems implementing and/or providing the embodiments of the present disclosure are transformed into faster and more operationally efficient devices and systems.

In addition to improving overall computing performance, by identifying and addressing potentially fraudulent activity in a financial system, implementation of embodiments of the present disclosure represent a significant improvement to the efficient use of human and non-human resources. As one illustrative example, by identifying and addressing fraudulent activity in user accounts, fewer recourses such as time and energy must be devoted to resolving issues associated with fraud.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for identifying and addressing potential fictitious business entity-based fraud, comprising:
providing, with one or more computing systems, a security system;
receiving filing data representing one or more tax return filings from one or more users of a financial system, the filing data including EIN data, the EIN data representing an Employer Identification Number (EIN);
providing predictive model data representing a predictive model that is trained to generate a risk assessment of a risk category at least partially based on the filing data including the EIN data;
applying the filing data including the EIN data to the predictive model data to transform the filing data including the EIN data into risk score data for the risk category, the risk score data representing a likelihood of potential fictitious business entity-based fraud in the financial system;
applying risk score threshold data to the risk score data for the risk category to determine if a risk score that is represented by the risk score data exceeds a risk score threshold that is represented by the risk score threshold data; and
if the risk score exceeds the risk score threshold, classifying the EIN data as potentially suspicious EIN data and executing risk reduction instructions to address the potential fictitious business entity-based fraud by performing one or more risk reduction actions to reduce a likelihood of potential fictitious business entity-based fraud activity.

2. The computing system implemented method of claim 1, wherein the risk category is selected from a group of risk categories, consisting of:
Employer Identification Number risk category;
Employer Identification Number characteristics risk category;
financial system product identifier risk category;
financial system product characteristics risk category;
system access characteristics risk category;
tax preparer characteristics risk category;
business entity characteristics risk category;
tax preparation characteristics risk category;
tax filing characteristics risk category;
user system characteristics risk category;
user system characteristics identifier risk category;
IP address risk category;
IP address identifier risk category;
user account risk category; and
user account identifier risk category.

3. The computing system implemented method of claim 1, wherein the risk category includes business entity characteristics, wherein at least one characteristic of the business entity characteristics includes one or more of the following characteristics of a business entity associated with the EIN:
age of the business entity;
change in number of employees of the business entity;
change in income of employee and/or employees of the business entity; and
change in income of the business entity.

4. The computing system implemented method of claim 1, wherein the risk category includes EIN characteristics, wherein at least one characteristic of the EIN characteristics includes one or more of the following characteristics of the EIN:
date of EIN creation; and
duration of EIN use by a business entity associated with the EIN.

5. The computing system implemented method of claim 1, wherein the risk category includes tax preparer characteristics, wherein at least one characteristic of the tax preparer characteristics includes a Preparer Tax Identification Number (PTIN) associated with a tax return preparer.

6. The computing system implemented method of claim 1, wherein the risk category includes tax preparer characteristics, wherein at least one characteristic of the tax preparer characteristics includes:
whether multiple tax filings associated with the EIN are prepared by one tax preparer;
a number of tax filings in the financial system that have been submitted by a tax preparer on behalf of other people; and
how long a tax preparer has used the financial system to prepare tax returns on behalf of other people.

7. The computing system implemented method of claim 1, further comprising:
requesting one or more of system access data, the filing data, financial data, user data, and user system data associated with the potentially suspicious EIN data; and
applying a predictive model training operation to one or more of the system access data, the filing data, the financial data, the user data, and the user system data associated with the potentially suspicious EIN data, to generate the predictive model data and to train the predictive model.

8. The computing system implemented method of claim 7, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

9. The computing system implemented method of claim 1, wherein the risk category includes system access characteristics, wherein at least one characteristic of the system access characteristics includes:
information submissions associated with the potentially suspicious EIN data; and
user experience navigation associated with the potentially suspicious EIN data in the financial system.

10. The computing system implemented method of claim 1, further comprising:
maintaining system access data, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access a user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

11. The computing system implemented method of claim 1, wherein the one or more risk reduction actions includes alerting the financial system of the likelihood of potential fictitious business entity-based fraud, to enable the financial system to increase scrutiny of activity associated with a potentially suspicious EIN that is represented by potentially suspicious EIN data and/or notify appropriate authorities.

12. The computing system implemented method of claim 1, wherein the one or more risk reduction actions includes one or more of:
notifying a state or federal revenue service of potentially fraudulent activity associated with the potentially suspicious EIN;
requesting information from a point of contact for the potentially suspicious EIN;
obtaining point of contact information for the potentially suspicious EIN from a secretary of state office to determine a financial history of a point of contact associated with the point of contact information;
suspending tax return filings associated with the potentially suspicious EIN;
suspending access to the financial system for user accounts associated with the potentially suspicious EIN; and
assigning customer support representatives for the financial system to contact people who were employed by the business entity associated with the potentially suspicious EIN.

13. A computing system implemented method for identifying and addressing potential fictitious business entity-based fraud, comprising:
providing, with one or more computing systems, a security system;
receiving tax preparation data representing tax preparation information from one or more users of a financial system, the tax preparation data including EIN data, the EIN data representing one or more Employer Identification Numbers (EINs) associated with one or more business entities;
providing predictive model data representing a predictive model that is trained to generate a risk assessment of a risk category at least partially based on the tax preparation data including the EIN data;
applying the tax preparation data including the EIN data to the predictive model data to generate risk score data for the risk category, the risk score data representing a likelihood of potential fictitious business entity-based fraud in the financial system;
applying risk score threshold data to the risk score data for the risk category to determine if a risk score that is represented by the risk score data exceeds a risk score threshold that is represented by the risk score threshold data; and
if the risk score exceeds the risk score threshold, classifying the EIN data as potentially suspicious EIN data and executing risk reduction instructions to address the potential fictitious business entity-based fraud by performing one or more risk reduction actions to reduce a likelihood of potential fictitious business entity-based fraud activity.

14. The computing system implemented method of claim 13, wherein the risk category is selected from a group of risk categories, consisting of:
Employer Identification Number risk category;
Employer Identification Number characteristics risk category;
financial system product identifier risk category;
financial system product characteristics risk category;
system access characteristics risk category;
tax preparer characteristics risk category;
business entity characteristics risk category;
tax preparation characteristics risk category;
tax filing characteristics risk category;
user system characteristics risk category;
user system characteristics identifier risk category;
IP address risk category;
IP address identifier risk category;
user account risk category; and
user account identifier risk category.

15. The computing system implemented method of claim 13, wherein the risk category includes business entity characteristics, wherein at least one characteristic of the business entity characteristics includes one or more of the following characteristics of a business entity associated with the EIN:
age of the business entity;
change in number of employees of the business entity;
change in income of employee and/or employees of the business entity; and
change in income of the business entity.

16. The computing system implemented method of claim 13, wherein the risk category includes EIN characteristics, wherein at least one characteristic of the EIN characteristics includes one or more of the following characteristics of the EIN:
date of EIN creation; and
duration of EIN use by a business entity associated with the EIN.

17. The computing system implemented method of claim 13, wherein the risk category includes tax preparer characteristics, wherein at least one characteristic of the tax preparer characteristics includes a Preparer Tax Identification Number (PTIN) associated with a tax return preparer.

18. The computing system implemented method of claim 13, wherein the risk category includes tax preparer characteristics, wherein at least one characteristic of the tax preparer characteristics includes:
whether multiple tax filings associated with the potentially suspicious EIN are prepared by one tax preparer;
a number of tax filings in the financial system that have been submitted by a tax preparer on behalf of other people; and
how long a tax preparer has used the financial system to prepare tax returns on behalf of other people.

19. The computing system implemented method of claim 13, further comprising:
requesting one or more of system access data, the tax preparation data, financial data, user data, and user system data associated with the potentially suspicious EIN data; and
applying a predictive model training operation to one or more of the system access data, the tax preparation data, the financial data, the user data, and the user system data associated with the potentially suspicious EIN data, to generate the predictive model data and to train the predictive model.

20. The computing system implemented method of claim 19, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

21. The computing system implemented method of claim 13, wherein the risk category includes system access characteristics, wherein at least one characteristic of the system access characteristics includes:
information submissions associated with the potentially suspicious EIN data; and
user experience navigation associated with the potentially suspicious EIN data in the financial system.

22. The computing system implemented method of claim 13, further comprising maintaining system access data, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access a user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

23. The computing system implemented method of claim 13, wherein the one or more risk reduction actions includes alerting the financial system of the likelihood of potential fictitious business entity-based fraud, to enable the financial system to increase scrutiny of activity associated with a potentially suspicious EIN represented by the potentially suspicious EIN data and/or notify appropriate authorities.

24. The computing system implemented method of claim 13, wherein the one or more risk reduction actions includes one or more of:
notifying a state or federal revenue service of potentially fraudulent activity associated with the potentially suspicious EIN;
requesting information from a point of contact for the potentially suspicious EIN;
obtaining point of contact information for the potentially suspicious EIN from a secretary of state office to determine a financial history of a point of contact associated with the point of contact information;
suspending tax return filings associated with the potentially suspicious EIN;
suspending access to the financial system for user accounts associated with the potentially suspicious EIN; and
assigning customer support representatives for the financial system to contact people who were employed by the business entity associated with the potentially suspicious EIN.

25. A computing program product for identifying and addressing potential fictitious business entity-based fraud, comprising:
a non-transitory computer readable medium; and
computer program code, encoded on the computer readable medium, comprising computer readable instructions, which, when executed by one or more processors, performs a process for identifying and addressing potential fictitious business entity-based fraud, the process for identifying and addressing potential fictitious business entity-based fraud including:
providing, with one or more computing systems, a security system;
receiving EIN data, the EIN data representing one or more Employer Identification Numbers (EINs) associated with one or more business entities;
providing predictive model data representing a predictive model that is trained to generate a risk assessment of a risk category at least partially based on the EIN data;
applying the EIN data to the predictive model data to generate risk score data for the risk category, the risk score data representing a likelihood of potential fictitious business entity-based fraud in a financial system;
applying risk score threshold data to the risk score data for the risk category to determine if a risk score that is represented by the risk score data exceeds a risk score threshold that is represented by the risk score threshold data; and
if the risk score exceeds the risk score threshold, classifying the EIN data as potentially suspicious EIN data and executing risk reduction instructions to address the potential fictitious business entity-based fraud by performing one or more risk reduction actions to reduce a likelihood of potential fictitious business entity-based fraud activity.

26. The computing program product of claim 25, wherein the risk category is selected from a group of risk categories, consisting of:
Employer Identification Number risk category;
Employer Identification Number characteristics risk category;
financial system product identifier risk category;
financial system product characteristics risk category;
system access characteristics risk category;
tax preparer characteristics risk category;
business entity characteristics risk category;
tax preparation characteristics risk category;
tax filing characteristics risk category;
user system characteristics risk category;
user system characteristics identifier risk category;
IP address risk category;
IP address identifier risk category;
user account risk category; and
user account identifier risk category.

27. The computing program product of claim 25, wherein the risk category includes business entity characteristics, wherein at least one characteristic of the business entity characteristics includes one or more of the following characteristics of a business entity associated with the EIN:
age of the business entity;
change in number of employees of the business entity;
change in income of employee and/or employees of the business entity; and
change in income of the business entity.

28. The computing program product of claim 25, wherein the risk category includes EIN characteristics, wherein at least one characteristic of the EIN characteristics includes one or more of the following characteristics of the EIN:
date of EIN creation; and
duration of EIN use by a business entity associated with the EIN.

29. The computing program product of claim 25, wherein the risk category includes tax preparer characteristics, wherein at least one characteristic of the tax preparer characteristics includes a Preparer Tax Identification Number (PTIN) associated with a tax return preparer.

30. The computing program product of claim 25, wherein the risk category includes tax preparer characteristics, wherein at least one characteristic of the tax preparer characteristics includes:
whether multiple tax filings associated with the potentially suspicious EIN are prepared by one tax preparer;
a number of tax filings in the financial system that have been submitted by a tax preparer on behalf of other people; and
how long a tax preparer has used the financial system to prepare tax returns on behalf of other people.

31. The computing program product of claim 25, further comprising:
requesting one or more of system access data, tax preparation data, financial data, user data, and user system data associated with the EIN data; and
applying a predictive model training operation to one or more of the system access data, the tax preparation data, the financial data, the user data, and the user system data associated with the EIN data, to generate the predictive model data and to train the predictive model.

32. The computing program product of claim 31, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

33. The computing program product of claim 25, wherein the risk category includes system access characteristics, wherein at least one characteristic of the system access characteristics includes:
information submissions associated with the potentially suspicious EIN data; and
user experience navigation associated with the potentially suspicious EIN data in the financial system.

34. The computing program product of claim 25, further comprising maintaining system access data, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access a user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

35. The computing program product of claim 25, wherein the one or more risk reduction actions includes alerting the financial system of the likelihood of potential fictitious business entity-based fraud, to enable the financial system to increase scrutiny of activity associated with an EIN and/or notify appropriate authorities.

36. The computing program product of claim 25, wherein the one or more risk reduction actions includes one or more of:
notifying a state or federal revenue service of potentially fraudulent activity associated with the potentially suspicious EIN;
requesting information from a point of contact for the potentially suspicious EIN;
obtaining point of contact information for the potentially suspicious EIN from a secretary of state office to determine a financial history of a point of contact associated with the point of contact information;
suspending tax return filings associated with the potentially suspicious EIN;
suspending access to the financial system for user accounts associated with the potentially suspicious EIN; and
assigning customer support representatives for the financial system to contact people who were employed by the business entity associated with the potentially suspicious EIN.
